(19) United States
(12) Patent Application Publication
(10) Pub. No.: US 2002/0104017 A1
(43) Pub. Date: Aug. 1, 2002

(54) Firewall system for protecting network elements connected to a public network

(76) Inventor: Rares Stefan, Montreal (CA)

Correspondence Address: GOUDREAU GAGE DUBUC, 800 PLACE VICTORIA, SUITE 3400, MONTREAL, QUEBEC, H4Z 1E9, CA

(21) Appl. No.: 09/773,057

(22) Filed: Jan. 30, 2001

(51) Int. Cl. G06F 12/14; G06F 12/16

(52) U.S. Cl. 713/201

(57) ABSTRACT

A firewall system for protecting network elements of computer systems against attack from hosts on the Internet is described herein. The firewall system comprises a front-end server attached to the Internet and a back-end server attached to and between the computer systems to protect the front-end server. The front-end server is configured to prevent all unrequested packets from directly reaching the back-end server and the computer systems attached thereto. The back-end server is configured to forward to the Internet any request originating form the computer systems and to gather signed packets stacked at the front-end server level.

### FIELD OF THE INVENTION

The present invention relates to network security. More specifically, the present invention is concerned with firewall systems.

### BACKGROUND OF THE INVENTION

Internet architecture generally dictates that any computer system that has to be successfully connected to the Internet must be provided with the following characteristics:

a Transmission Control Protocol/Internet Protocol (TCP/IP) compliant Operating System (OS);

a TCP/IP protocol installed and configured correctly;

a static or dynamically assigned IP address; and

configured to allow Internet packets to flow to and from the assigned Internet address.

These conditions imply that, if a computer system is configured to communicate with other systems over the Internet, then the computer system is exposed to incoming attacks.

Conventional firewall systems (hereinafter simply referred to as “firewalls”) are believed to be well known in the art. They include hardware and software components that are connected between one or more network elements that are to be protected and other network elements to be protected from. These other network elements are usually part of the Internet or of another public network.

Generally stated, firewalls are configured to allow unidirectional access to the public network via the network elements protected by the firewall, while preventing unauthorized access to these network elements via the public network.

As used herein, the term “network element” refers to any devices associated with a computer network, such as computers, network routers, servers, hosts, printers and databases.

Firewalls can be configured according to different architectures, providing various levels of security at different costs for installation and operation. Known firewall architectures include multi-homed host firewall, screened host firewall and screened subnet firewall.

Referring to FIG. 1 of the appended drawings, which is labelled prior art, a network incorporating a firewall arrangement according to the prior art will be described.

The network 10 includes a computer system 12 connected to a public network such as the Internet 14.

The term “public network” will often be used herein when referring to the parts of a network to which a computer system is attached, even though the computer system is also part of such public network since they are obviously directly or indirectly, permanently or temporally attached thereto.

The computer system 12 includes a plurality of network elements 16 that communicate via packets and through a router 18, with network elements from the Internet 14. As it is commonly known in the art, the router 18 directs packets according to address information contained in each packet. Since routers are believed to be well Known in the art, they will not be described herein in more detail.

The computer system 12 includes a firewall 20 connected to the router 18 and to the networks element via switching hubs 22 and 24 respectively. The firewall 20 is connected between the network elements 16 and the Internet 14 to ensure that every packet coming from the Internet 14 passes through the firewall 20.

One technique that can be used by the firewall 20 is known as “packet filtering”. Such technique involves the investigation of the address information contained in each packet and the use of a predetermined set of rules to decide if the packet is allowed to be forwarded to its destination network element 16. Those sets of rules are based on the address (or port) from which the packet originates.

A first drawback of packet filtering arises when the set of rules allows passing through any packet having a source address unknown to the filter. It is indeed often assumed that a packet that is not recognized by the filter will be recognized downstream of the packet filter. However, this practice allows hackers (computer users having malicious intent) to bypass the packet filter.

Another way for hackers to bypass the packet filter is known as “IP/MAC (Medium Access Control) spoofing”. This is achieved by modifying the address information of a prefabricated and dedicated packet. for example by making the firewall believes that such a packet is originating from the inside. The packet then generally passes through the firewall 20 since most conventional firewalls are transparent to messages originating from behind the firewall, i.e. on the side of the network elements to be protected.

Conventional firewalls also often use an application gateway or proxy system. These systems operate on a computing platform OS. Among other functions, they receive and monitor incoming/outgoing connection requests. This is achieved by monitoring the element of packets that indicates the nature of a service associated with a packet. Those elements are known as port numbers. Each service is associated with a specific port number that allows the OS or the monitoring application to open a connection to that port. Examples of such services include HTTP, Telnet, EMAIL, etc. The function of the application gateway or proxy is to validate such port opening and to filter content.

As can be seen In FIG. 1, a web server 26 and an email server 28 are connected to the firewall 20 via the hub 22. Since these services must communicate with the network elements 16, they provide a potential path through which a hacker can get behind the firewall 20. Indeed, the web server 26 and the email server 28 may have authority to communicate through the firewall 20. A hacker may use an open communication path between one of these services 2628 and one of the network elements 16 to route packets through. He can also exploit the same technique to attack the firewall directly.

In general, any firewall implementation may present a computer hacker with the following vulnerabilities to exploit:

mis-configuration of the firewall rules sets;

vulnerabilities in the OS TCP/IP implementation running on the exposed firewall system;

vulnerabilities in the networking services, such as mail services web services and DNS (Domain Name System) services running on the firewall. Indeed, these public servers represent a potential risk for network integrity. Since these servers are exposed to traffic from the Internet, a malicious user may seek to exploit weaknesses in these systems;

servers running public applications. Indeed, while most firewalls offer a protected DMZ (DiMilitarized Zone), this protection refers to the OS on which the firewall is implemented and not to the security of the application running on the server; and

remote administration services exposed to connection hijacking.

Since DMZ are believed to be well known in the art, R will not be described herein in more detail.

### SUMMARY OF THE INVENTION

More specifically, in accordance with the present invention, there is provided a firewall system for preventing non-requested packets coming from a public network from reaching network elements connected thereto, the firewall system comprising:

a front-end server having internal and external interfaces; the front-end server external interface being attached to the public network; the front-end server being configured to drop non-requested incoming packets from the public network; the non-requested packets including signed packets and unsigned packets: and

a back-end server having internal and external interfaces; the back-end internal interface being attached to the network elements and to the front end internal interface via the back-end external interface; the back-end server being so configured as to gather packets requested by the network elements from the public network, and signed packets from the front-end server; the back-end server being configured so as to prevent leaks from the network elements.

Other objects, advantages and features of the present invention will become more apparent upon reading the following non-restrictive description of preferred embodiments thereof, given by way of example only with reference to the accompanying drawings.

### BRIEF DESCRIPTION OF THE DRAWINGS

In the appended drawings:

FIG. 1, which is labeled “prior art”, is a block diagram of a computer network incorporating a firewall system according to the prior art; and

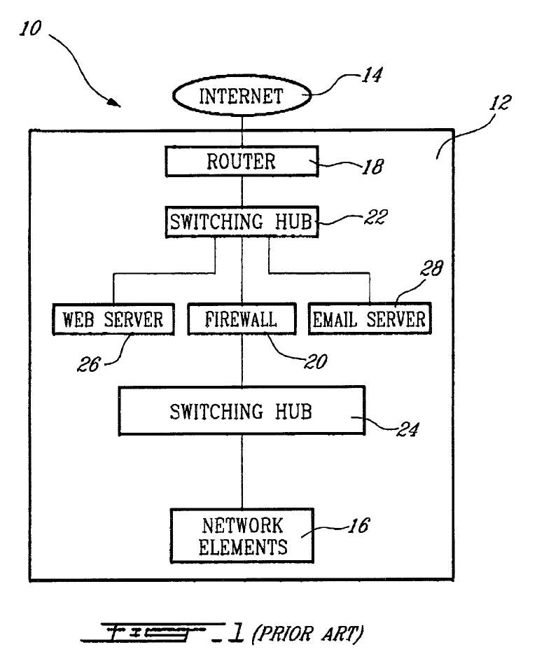

FIG. 2 is a block diagram of a computer network incorporating a firewall according to an embodiment of the present invention.

### DESCRIPTION OF THE PREFERRED EMBODIMENT

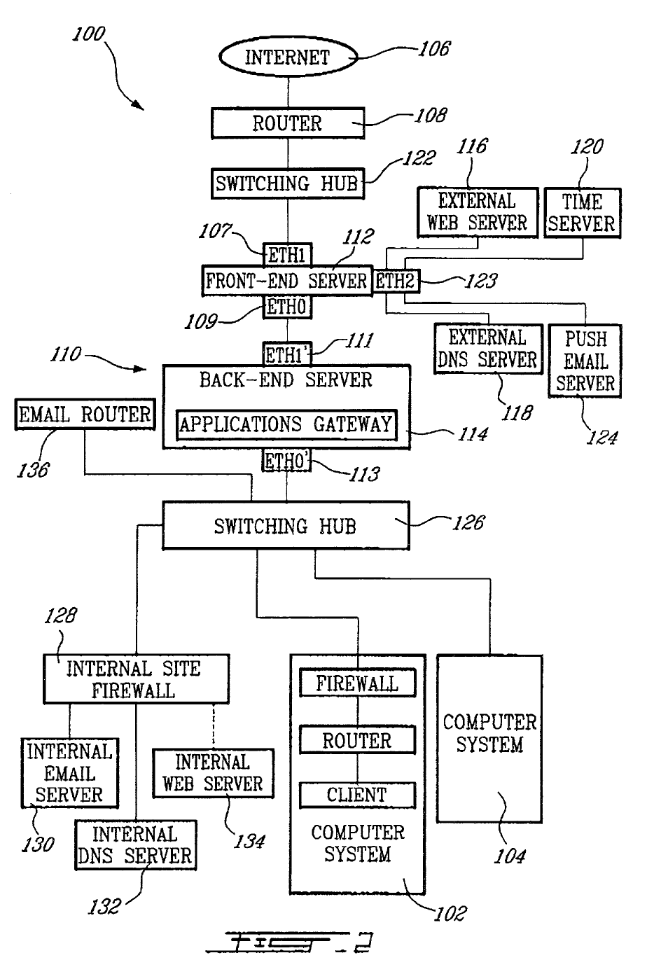

Turning now to FIG. 2 of the appended drawings, a network 100, including a firewall system according to a preferred embodiment of the present invention, will be described.

The overall network 100 comprises two computer systems 102 and 104, attached via a router 108 to a public network such as the Internet 106 and protected by a firewall system, as will be explained hereinbelow.

The number and nature of the computer systems that are protected by the firewall system may obviously vary without departing from the spirit of the present invention.

The firewall system is attached to the Internet 106 and to the computer systems 102 and 104. The firewall system allows, among other things, the prevention of non-requested packets, coming from the Internet 106, to reach network elements (not shown) of the computer systems 102 and 104. Therefore, the firewall system protects the computer systems 102 and 104 against malicious attacks that originate from the Internet 106. Furthermore, as will be described hereinbelow, the firewall system protects the computer systems 102-104 from maliciously attacking one another.

Indeed, it is to be noted that the Internet is used herein only as an example and that a firewall system, according to the present invention, generally allows protecting network elements from being hacked by other network elements sharing common network connections.

Generally stated, the firewall system includes hardware and software logical and physical layout that prevents remote attacks by making use primarily of a virtual IP technique through which the firewall system communicates with the Internet without having the IP assigned to its external interface ETH1 107. In addition, this layout also prevents the exploitation of unknown vulnerabilities within an OS kernel and/or TCP/IP implementation.

More specifically, the firewall system comprises a front-end server 112, attached to the Internet 106 via its external interface

ETH1 107 and a back-end server 114 attached to the computer systems 102 and 104 via its internal interface ETHO′ 113 and to the interface ETHO 109 of the front-end server 112 through its external interface ETH1′ 111.

The internal and external interfaces 107, 109, 111, 113 and 123 of the front and back-end servers 112 and 114 may take many forms, depending on The computer system and the platform on which the servers 112 and 114 are implemented.

Although ETH refers herein to ethernet cards, other means to interconnect the servers 112 and 114 under the Internet Protocol can also be used. Since ethernet cards are believed to be well known in the art, they will not be described herein in more detail.

The two servers 112 and 114 are advantageously configured with two different OS. For example, the front-end server 112 may be mounted on a LINUX platform and the back-end server 114 may be mounted on a WINDOWS NT™ platform, This allows for redundancy in TCP/IP security since a computer hacker would have to exploit two sets of flaws to, at least, be able to send Internet Packets to the internal systems 102 and 104. Obviously, other platforms can also be used.

It is to be noted that the expression “server” is not intended here to limit the scope of the present invention and is only used as a possible embodiment. Any network element configured to provide the functionality that will be described herein can alternatively be used.

The back-end server 114 advantageously acts as an application gateway and includes a proxy service, while Network Address Translation (NAT) is implemented on the front-end server 112.

External web servers 116, DNS servers 118 and time server 120 are attached to the front-end server via a first conventional switching hub 122 and the interface ETH2 123. The interface 123 is configured to provide a DMZ area for the servers 116 and 118. The word “external” refers here to the fact that these servers are on the side of the network 100 not protected by the firewall system. An external email server 124 is also attached to the front-end server 112 within the DMZ area. The interface 123 is configured to protect servers 116, 118 and 124 by denying any Internet packets addressed to them except for the ones relevant to the services running on them.

The computer systems 102 and 104 are attached to the internal interface ETHO′ of the back-end server 114 via a second conventional switching hub 126.

An internal site firewall 128 is advantageously attached to the back-end server 114 via the switching hub 126, and internal email 130, DNS 132 and internal web 134 servers are attached to the internal firewall 128.

The internal site firewall allows protecting the computer system 102 and 104 against each other by physically and logically separating the computer systems 102 and 104. This technique is generally known as net-to-host routing. Since such technique is believed to be well known in the art, it will not be described herein in more detail.

The configuration of the internal site firewall 128 may vary according to the risk of attack between the computer systems 102 and 104 to be protected against hacking. Ultimately, a firewall system according to the present invention could be used.

As will become more apparent upon reading the following description, the firewall system is configured to drop all non-requested packets on the front-end server 112, while the back-end server 114 is configured to gather packets that are requested by the network elements of the computer systems 102 and 104 from the Internet 106.

A distinction is made herein between packets that come from the Internet 106 following a request from one of the computer systems 102 and 104, and packets that come form the Internet 106 without such a request.

In addition to information regarding its source and destination port address, a packet conventionally contains information about the type of information it contains (or the protocol that is used to communicate that packet over a network). This information is what is referred to herein as the packet type. For example, packets issued from the Simple Mail Transfer Protocol (SMTP), File Transfer Protocol (FTP) and Hyper Text Transfer Protocol (HTTP) all have a distinct signature.

The front-end server 112 is configured to drop all un-requested packets, i.e. all signed packets are forwarded to the corresponding external service or dropped. For example, no email is allowed to pass through the front-end server 112 directly to the back-end server 114.

All unsigned packets are dropped by the front-end server 112, i.e. these packets are not forwarded to any other nods of the network 100. This fends-off any attack based on IP stack vulnerabilities. Examples of such attacks include IP spoofing, MAC spoofing, source routing fragmentation, syn scan, etc.

Moreover, the external interface ETH1′ of the back-end server 114 is configured to drop any request originating from the front-end server 112, therefore eliminating the possibility of a packet to bypass the front-end server 112. All Internet packets that are not requested by the internal interface ETHO′ 113 of the back-end server 114 are dropped by the back-end server 114.

Both servers 112 and 114 implement IP filtering advantageously enabled with the same set of rules. In this way, if an undocumented packet flow appears, the host will not be exposed to a hacker.

The IP filtering may be done simultaneously by two different mechanisms implemented on the servers 112 and 114 to provide additional security if one of the two mechanisms fail.

The firewall system 100 allows for securing the email by employing a push mail server 124 to receive email coming from the Internet 106. The back-end server 114 is configured to transfer emails from the push mail server 124 to the internal email server 130. A hacker cannot gain legitimate access to the SMTP service of the email server 130, but is rather limited to the SMTP service of the push mail server 124 where advantageously no email accounts exists.

Before being forwarded to the internal email server 130, every email in the push email server 124 is verified for possible malicious content.

More precisely, all active content is removed from the email. Such active content may include ActiveX, Java script, etc. All attachments are also advantageously removed and then scanned for known viruses using conventional virus scanning software.

More generally, the front-end server 112 is configured to examine every request sent to one of the external servers 116, 118, 120 and 124 and allows the request to be passed to the corresponding server if they do not contain potentially malicious commands or code. Moreover, the IP of any hacker is advantageously detected and further access is denied.

Some procedure may be performed to minimize the attack through requested packets. For example, HTTP based downloads could be password-protected. This can be implemented by each computer system 102 and 104.

To prevent leaking of information, such as data residing on one of the internal servers 102 and 104, it may be advantageous, for example, to deny post-put operations larger than 10 kilobytes and to deny put through FTP transfer. Other rules may also be implemented by the servers 112 and 114 to prevent a leak.

The Internet traffic generated by one of the internal servers 102 and 104 is directed to the internal interface ETHO′ of the back-end server 114. This server uses an application gateway that acts as an intermediary between the internal servers 102-104 and the Internet 106.

Any possibility of planting a trojan behind the firewall is eliminated since the back-end server 114 captures any request from server 102 or 104 and analyses it for legitimacy before passing it to the Internet 106. This eliminates the possibility of planting a Trojan since, even if a malicious code does get installed on one of the internal server 102 or 104 or to a computer system connected thereto, a hacker cannot see the system in question and is therefore unable to connect thereto.

Another Trojan technique consists in installing a malicious code on one of the internal systems to “tunnel” data from the internal systems 102-104 to the Internet 106 via legitimate traffic. This kind of attack is prevented by a firewall system according to the present invention since the back-end server 114 is configured for detecting transfer of data from the internal systems 102-104 to the Internet 106.

At the computer systems 102 and 104 level, the domain names are resolved using the internal DNS server 132 attached to the internal site firewall 128. DNS queries are made by the back-end server 114 to the external DNS server 118 to update the internal DNS server 132.

Moreover, the NAT implementation on the front-end server 112 does not allow DNS to pass. This is advantageous since it prevents any possibility of trojan attacks on the back-end server via DNS. Trojan attacks are believed to be well known in the art and will therefore not be described herein.

Alternatively, it may be advantageous to attach an additional external DNS server (not shown) to the front-end server 112 to provide redundancy.

The functions of web, time and DNS server are believed to be well known in the art and will not be described herein in more detail.

Obviously, there can be more than one external web server 134 attached to the front-end server 112

The internal web server 134 serves the same purpose as the external web server(s) 116, which is to generally display web content Internet users or provide online services. The major difference being that the internal web server 134 is protected by the firewall system. Again there can be more than one internal web server attached to back-end server 114 via the optional internal site firewall 128.

The internal and external web servers 134 and 116 are obviously optional and so are the DNS servers 118 and 132. However, a network element part of the computer systems 102 and 104 would not be able to resolve domain names without the DNS servers 118 and 132.

Computer systems 102 and 104 may have different configurations. Furthermore, one the computer systems 102 and 104 could be an Internet service provider that would provide Internet access to other computer systems (not shown).

Different access may be provided to the user of the computer systems 102 and 104. For example, a user can be connected either by a conventional network connection, by an access server (not shown), or by using a terminal. However, to help prevent an attack by an end-user having remote access to one of the computer systems 102-104, it may be advantageous to allow such remote access only through the firewall system.

It is to be noted that different internal security policies may be implemented in each computer system 102 and 104 without compromising the security of another computer system protected by the firewall system 100.

According to a most preferred embodiment of the present invention, there are two parallel front-end and back-end servers that provide the same function. This allows for achieving zero downtime. Indeed, it is believed to be unlikely that two servers having the same function be down simultaneously.

The fact that the front and back-end servers 112 and 114 are implemented on two different OS is also advantageous, since it is believed to be very unlikely for two different OS to have major holes or bugs discovered simultaneously.

The following are examples of possible attacks on the computer systems 102-104 and on the firewall system, and responses to these attacks from the firewall system. It is believed that those examples will help to illustrate the function as well as the advantages of a firewall system according to the present invention. Since these attacks are believed to be well documented in the art, and for concision purposes, they will not be described herein in detail.

Any passive attack such as zone transfers lookups and “whois” lookup will direct the attacker to the IP address at the front-end server 112, therefore preventing a hacker from gathering relevant intelligence from the computer systems 102 and 104 and also from the back-end server 114.

A conventional scan will return a non-responsive host.

A specially crafted scan will return a live host having all ports filtered. This is achieved since the external interface of the front-end server 112 drops all packets.

A fragmentation attack with a legitimate origin source port (80, for example) is fended off by the stacking packet implementation on the front-end server 112.

Any attempt to DOS (Denial Of Service) the front-end server 112, by sending specially crafted packets as if it was originating from the internal interface ETHO′ of the back-end server 114, will be denied by the filter rules that are implemented on the front and back-end server interfaces 107-111.

There is no possibility for exploiting a service on the front-end server since those services are provided by independent servers (see, for example, 116, 118, 120 and 124).

It will be useless for a hacker to attempt to open a gateway (or tunnel) to bypass the firewall system, since the hosts on the computer systems 102 and 104 have no direct connection to the Internet 106.

The application gateway parameters on the back-end server 114 can be set to deny legit packet transfer to tunnel malicious activities through the firewall system. The last two examples illustrate how leaks can be prevented from the networks elements of the computer systems 102 and 104.

Although the present invention has been described hereinabove by way of preferred embodiments thereof, A can be modified without departing from the spirit and nature of the subject invention, as defined in the appended claims.

What is claimed is:

1. A firewall system for preventing non-requested packets coming from a public network from reaching network elements connected thereto, said firewall system comprising:
a front-end server having internal and external interfaces; said front-end server external interface being attached to the public network; said front-end server being configured to drop non-requested incoming packets from the public network; said non-requested packets including signed packets and unsigned packets; and
a back-end server having internal and external interfaces; said back-end internal interface being attached to the network elements and to said front end internal interface via said back-end external interface; said back-end server being so configured as to gather packets requested by the network elements from the public network, and signed packets from the front-end server; said back-end server being configured so as to prevent leaks from the network elements.

2. A firewall system as recited in claim 1, wherein at least one of said front-end and back-end servers is configured to implement IP filtering.

3. A firewall system as recited in claim 2, wherein said front-end and back-end servers implement IP filtering according to the same rules.

4. A firewall system as recited in claim 1, wherein said back-end server is configured to capture at least one request from one of the network elements and to analyse said request for legitimacy before passing it to the public network.

5. A firewall system as recited in claim 1, wherein said back-end server is configured to detect a transfer of data from the network elements to the public network.

6. A firewall system as recited in claim 1, wherein at least one of said back-end internal and external interfaces and front-end internal and external interfaces is in the form of an ethernet card.

7. A firewall system as recited in claim 1, wherein said front-end server is configured with a first OS (Operating System) and said back-end server is configured with second OS.

8. A firewall system as recited in claim 7, wherein said first and second OS are different.

9. A firewall system as recited in claim 1, wherein said back-end server includes an application gateway.

10. A firewall system as recited in claim 1, wherein said back-end server includes a proxy service.

11. A firewall system as recited in claim 1, wherein said front-end server is so configured as to provide NAT (Network Address Translation).

12. A firewall system as recited in claim 11, wherein said NAT is so implemented as to not allow DNS (Domain Name System) to pass.

13. A firewall system as recited in claim 1, wherein said front-end server includes a third interface.

14. A firewall system as recited in claim 13, further comprising at least one of a DNS server, a web server, an email server and a time server connected to said third interface of the front-end server and wherein said third interface is configured so as to provide a DMZ (DiMilitarized Zone) for said at least one of a DNS server, a web server, an email server and a time server.

15. A firewall system as recited in claim 14, wherein said front-end server is configured to examine request sent to one of said at least one of DNS, web, email and time servers for potentially malicious commands.

16. A firewall system as recited in claim 13, further comprising a push mail server connected to said third interface of the front-end server and wherein said third interface is configured so as to provide a DMZ for said push mail server.

17. A firewall system as recited in claim 16, further comprising an internal email server connected to said internal interface of said back-end server; wherein said back-end server is configured to transfer email from said push mail server to said internal email server; whereby no email is allowed to pass through said front-end server directly to said back-end server.

18. A firewall system as recited in claim 16, wherein said push mail server is being configured to verify email for malicious content.

19. A firewall system as recited in claim 18, wherein said push mail server is configured to remove active content form emails.

20. A firewall system as recited in claim 18, wherein said push mail server is configured to scan emails for viruses.

21. A firewall system as recited in claim 17, further comprising an internal site firewall attached to said internal interface of said back-end server; said internal mail server being attached to said internal site firewall.

22. A firewall system as recited in claim 21, further comprising a DNS server attached to said internal site firewall.

23. A firewall system as recited in claim 21, further comprising a web server attached to said internal site firewall.

24. A firewall system as recited in claim 1, wherein said front-end server is attached to the public network via a router.

25. A firewall system as recited in claim 1, wherein said public network is the internet.
